(19) United States
(12) Patent Application Publication
(10) Pub. No.: US 2025/0156723 A1
(43) Pub. Date: May 15, 2025

(54) OBJECT DETECTION APPARATUS AND METHOD FOR TRAINING MODEL THEREOF

(71) Applicants: HYUNDAI MOTOR COMPANY, SEOUL (KR); KIA CORPORATION, SEOUL (KR)

(72) Inventor: Jun Hyeop Lee, Hwaseong-si (KR)

(73) Assignees: HYUNDAI MOTOR COMPANY, SEOUL (KR); KIA CORPORATION, SEOUL (KR)

(21) Appl. No.: 18/823,977

(22) Filed: Sep. 4, 2024

(30) Foreign Application Priority Data
Nov. 9, 2023 (KR) 10-2023-0154828

(51) Int. Cl. G06N 3/096; G06N 3/045

(52) U.S. Cl. CPC G06N 3/096; G06N 3/045

(57) ABSTRACT

An object detection apparatus for providing a training technique for improving the performance of an object detection model includes a memory storing an object detection model and a processor that trains the object detection model. The processor augments input data to generate first augmented data and second augmented data, respectively inputs the first augmented data and the second augmented data to a first network model and a second network model, and trains the object detection model based on an output of the first network model and an output of the second network model.

### CROSS REFERENCE TO RELATED APPLICATIONS

This application claims the benefit of priority to Korean Patent Application No. 10-2023-0154828, filed in the Korean Intellectual Property Office on Nov. 9, 2023, the entire contents of which are incorporated herein by reference.

### TECHNICAL FIELD

The present disclosure relates to an object detection apparatus for providing a training technique for improving the performance of an object detection model.

### BACKGROUND

Feature representation learning has distinguished itself in the field of unsupervised learning and is also applied to the field of three-dimensional (3D) object detection. As the batch size increases, a contrastive loss most used in the field of feature representation learning shows high performance. When the batch size decreases, the contrastive loss is difficult to be applied.

### SUMMARY

The present disclosure has been made to solve the above-mentioned problems occurring in the prior art while advantages achieved by the prior art are maintained intact.

An aspect of the present disclosure provides an object detection apparatus for training an object detection model using a feature representation learning technique which uses a distillation loss and a method for training a model thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an object detection apparatus may include a memory storing an object detection model and a processor that trains the object detection model, The processor may augment input data to generate first augmented data and second augmented data, may respectively input the first augmented data and the second augmented data to a first network model and a second network model, and may train the object detection model based on an output of the first network model and an output of the second network model.

The processor may calculate a distillation loss for each object based on first low-level object information output from the first network model and second low-level object information output from the second network model, may calculate a distillation loss for each class based on first high-level object information output from the first network model and second high-level object information output from the second network model, and may apply the distillation loss for each object and the distillation loss for each class to train the object detection model.

The processor may extract the first high-level object information from the first low-level object information using a convolution layer and may extract the second high-level object information from the second low-level object information using the convolution layer.

The first low-level object information and the second low-level object information may be defined as class-agnostic information which does not include class information.

The first high-level object information and the second high-level object information may be defined as class-aware information including class information.

The processor may calculate the distillation loss for each object and the distillation loss for each class using a mean squared error (MSE) loss function.

The processor may calculate an average of all proposals representing a kth object in each of the first low-level object information and the second low-level object information and may calculate the distillation loss for each object based on the calculated average.

The processor may calculate an average of all proposals representing all objects included in an nth class in each of the first high-level object information and the second high-level object information and may calculate the distillation loss for each class based on the calculated average.

The first network model may output a weight as a trained result and shares the weight with the second network model using an exponential moving average (EMA). The second network model may update its weight using the weight shared by the first network model.

The processor may perform global augmentation of the input data to generate the first augmented data and may apply random global rotation to the first augmented data to generate the second augmented data.

According to another aspect of the present disclosure, a method for training a model of an object detection apparatus may include augmenting input data to generate first augmented data and second augmented data, respectively inputting the first augmented data and the second augmented data to a first network model and a second network model, and training an object detection model based on an output of the first network model and an output of the second network model.

The training of the object detection model may include calculating a distillation loss for each object based on first low-level object information output from the first network model and second low-level object information output from the second network, calculating a distillation loss for each class based on first high-level object information output from the first network model and second high-level object information output from the second network model, and applying the distillation loss for each object and the distillation loss for each class to train the object detection model.

The calculating of the distillation loss for each class may include extracting the first high-level object information from the first low-level object information using a convolution layer and extracting the second high-level object information from the second low-level object information using the convolution layer.

The training of the object detection model may include calculating the distillation loss for each object and the distillation loss for each class using an MSE loss function.

The calculating of the distillation loss for each object may include calculating an average of all proposals representing a kth object in each of the first low-level object information and the second low-level object information and calculating the distillation loss for each object based on the calculated average.

The calculating of the distillation loss for each class may include calculating an average of proposals representing all objects included in an nth class in each of the first high-level object information and the second high-level object information and calculating the distillation loss for each class based on the calculated average.

The method may further include outputting, by the first network model, a weight as a trained result, sharing, by the first network model, the weight with the second network model using an EMA, and updating, by the second network model, its weight using the weight shared by the first network model.

The generating of the first augmented data and the second augmented data may include performing global augmentation of the input data to generate the first augmented data and applying random global rotation to the first augmented data to generate the second augmented data.

### BRIEF DESCRIPTION OF THE FIGURES

The above and other objects, features and advantages of the present disclosure will be more apparent from the following detailed description taken in conjunction with the accompanying drawings:

FIG. 1 is a block diagram illustrating a configuration of an object detection apparatus according to embodiments of the present disclosure;

FIG. 2 is a drawing illustrating a structure of a deep learning network according to embodiments of the present disclosure;

FIG. 3 is a drawing illustrating a method for training an object detection model according to embodiments of the present disclosure;

FIGS. 4 and 5 are drawings for describing the result of evaluating a method for training an object detection model according to embodiments of the present disclosure; and

FIG. 6 is a block diagram illustrating a computing system for executing a method for training an object detection model according to embodiments of the present disclosure.

### DETAILED DESCRIPTION

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

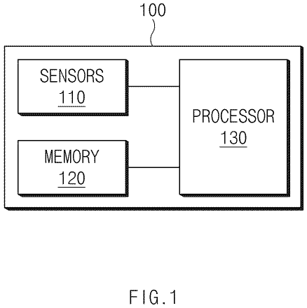

FIG. 1 is a block diagram illustrating a configuration of an object detection apparatus according to embodiments of the present disclosure.

An object detection apparatus 100 may be mounted on a vehicle to detect three-dimensional (3D) information (or 3D object information) for an object (e.g., a pedestrian, a vehicle, a bus, a truck, and/or the like) around the vehicle.

Referring to FIG. 1, the object detection apparatus 100 may include sensors 110, a memory 120, a processor 130, and the like.

The sensors 110 may obtain surrounding information of the vehicle. The surrounding information may be point cloud data, image data, or the like. The sensors 110 may include light detection and ranging (LiDAR), an image sensor, and/or the like.

The memory 120 may store a dataset which is training data. The training data may include ground truth (GT) data which is experimental information about an object. The training data may be generated as a database including a GT label and point cloud data associated with the GT label. The memory 120 may store an object detection model which is a training target. The memory 120 may store a training model to which a deep learning network is applied.

The memory 120 may store information obtained by the sensors 110. Furthermore, the memory 120 may store preset information and input data and/or output data of the processor 130.

The memory 120 may be a non-transitory storage medium which stores instructions executed by the processor 130. It is shown that the memory 120 is located outside the processor 130, but not limited thereto. The memory 120 may be located inside the processor 130. The memory 120 may include at least one of storage media such as a flash memory, a hard disk, a solid state disk (SSD), universal flash storage (UFS), a random access memory (RAM), a static RAM (SRAM), a read only memory (ROM), a programmable ROM (PROM), an electrically erasable and programmable ROM (EEPROM), or an erasable and programmable ROM (EPROM).

The processor 130 may include at least one of processing devices such as an application specific integrated circuit (ASIC), a digital signal processor (DSP), programmable logic devices (PLD), a field programmable gate array (FPGA), a central processing unit (CPU), a microcontroller, or a microprocessor.

The processor 130 may train the object detection model using a training model for supervised learning. The processor 130 may perform feature representation learning which uses a distillation loss for the object detection model. A mean squared error (MSE) loss between positive pairs may be applied to the distillation loss. In other words, the processor 130 may train the object detection model using a feature representation learning technique which uses the MSE loss. The processor 130 may store the trained object detection model in the memory 120.

The MSE loss is a loss function most used in self-supervised learning and knowledge distillation methodology. When the MSE loss is applied to the knowledge distillation methodology, a student model may be trained by following feature representation of a teacher model as it is. In other words, the MSE loss may be used to follow high-level feature representation in a late layer or a deep layer, such that a high-level feature is extracted even in an early layer for extracting a low-level feature.

The processor 130 may execute the trained object detection model and may recognize a surrounding object using the executed object detection model. The processor 130 may input the point cloud data (or the image data) obtained by the sensors 110 to the object detection model. The object detection model may recognize an object from the point cloud data and may output the result of recognizing the object. The result of recognizing the object may include an object class, an object position, and/or the like.

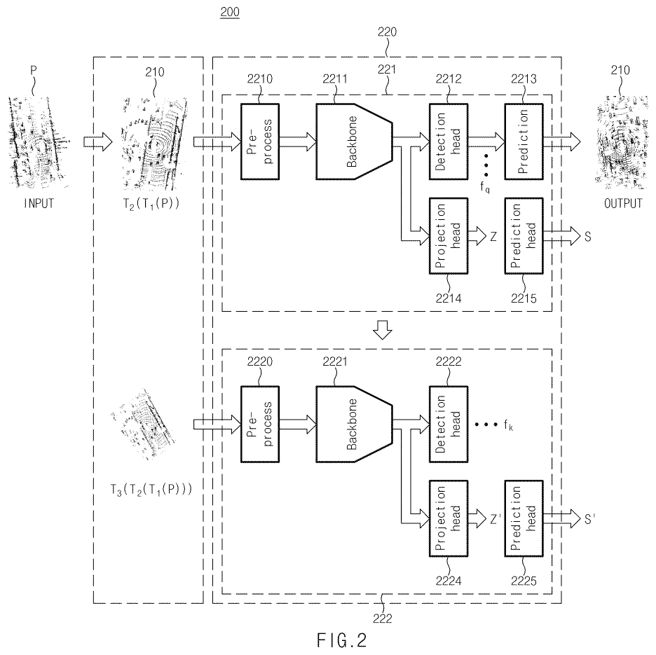

FIG. 2 is a drawing illustrating a structure of a deep learning network according to embodiments of the present disclosure.

Referring to FIG. 2, a deep learning network 200 may include a data augmentation model 210 and a training model 220. The deep learning network 200 may be executed by a processor 130 shown in FIG. 1.

The data augmentation model 210 may receive point cloud data P. The data augmentation model 210 may perform data augmentation using the received point cloud data P. The data augmentation model 210 may provide the training model 220 with the augmented data as training data.

The data augmentation model 210 may apply GT data sampled by means of ground truth (GT) sampling to the received point cloud data P. In detail, the data augmentation model 210 may randomly sample at least one piece of GT data among pieces of GT data included in a dataset stored in a memory 120. The data augmentation model 210 may randomly arrange the sampled GT data on the received point cloud data P. The data augmentation model 210 may output data T₁(P) in which the sampled GT data is randomly arranged on the point cloud data P as GT-sampled data.

The data augmentation model 210 may perform global augmentation to augment the GT-sampled data T₁(P). In other words, the data augmentation model 210 may primarily augment the GT-sampled data T₁(P) in a technique such as rotation, translation, and/or scale. The data augmentation model 210 may output the primarily augmented data T₂(T₁(P)). The data augmentation model 210 may apply random global rotation to the primarily augmented data (hereinafter referred to as “first augmented data”) T₂(T₁(P)) to perform secondary data augmentation. The data augmentation model 210 may output the secondarily augmented data (hereinafter referred to as “second augmented data”) T₃(T₂(T₁(P))) by means of the random global rotation. The data augmentation model 210 may transmit the first augmented data T₂ and the second augmented data T₃ to the training model 220.

The training model 220 may perform training using a knowledge distillation technique. The training model 220 may train an object detection model by using the first augmented data T₂ and the second augmented data T₃, which are provided from the data augmentation model 210, as training data.

The training model 220 may include a first network model 221 and a second network model 222. The first network model 221 may be a student network, and the second network model 222 may be a mean teacher network.

The first network model 221 may perform training using the first augmented data T₂ input from the data augmentation model 210. The first network model 221 may output a weight, which is hyperparameters, as the trained result. The first network model 221 may deliver (or share) the hyperparameters which are the trained result to the second network model 222 using an exponential moving average (EMA).

The first network model 221 may include a pre-process layer 2210, a backbone layer 2211, a detection head layer 2212, a prediction layer 2213, a projection head layer 2214, and a prediction head layer 2215. The first network model 221 may include an object detection model which is a training target. The object detection model may include the pre-process layer 2210, the backbone layer 2211, the detection head layer 2212, and the prediction layer 2213.

The pre-process layer 2210 may receive the first augmented data transmitted from the data augmentation model 210. The pre-process layer 2210 may pre-process and output the received first augmented data.

The backbone layer 2211 may extract a global feature (or a feature map) from the pre-processed first augmented data.

The detection head layer 2212 may detect (or recognize) an object based on the global feature extracted by the backbone layer 2211. The detection head layer 2212 may detect at least one object from the pre-processed first augmented data using a region proposal network (RPN). When receiving the feature map, the RPN may propose a region where the object may be. The RPN may classify an anchor box as a positive anchor box or a negative anchor box depending on an intersection over union (IoU) overlapping with the GT box. The RPN may determine which GT and IoU are highest for each anchor, may assign a label to the highest GT and IoU, and may use the GT and IoU to which the label is assigned for training.

The detection head layer 2212 may estimate and output a class probability and an object position probability for the detected object. The detection head layer 2212 may output a probability of each class (i.e., the class probability) for the detected object. For example, the detection head layer 2212 may estimate and output a probability that the detected object will be a car, a probability that the detected object will be a pedestrian, a probability that the detected object will be a bus, a probability that the detected object will be a truck, a probability that the detected object will be a van, and the like. Furthermore, the detection head layer 2212 may estimate a probability that the detected object will be located at a specific point (i.e., the object position probability).

The prediction layer 2213 may predict a class and/or a position of the detected object based on the probability output from the detection head layer 2212.

The projection head layer 2214 may extract low-level object information (or first low-level object information) z from the global feature extracted by the backbone layer 2211. The low-level object information z may be defined as class-agnostic information or instance-wise information in which there is no class information.

The prediction head layer 2215 may extract high-level object information (or first high-level object information) s from the low-level object information using a convolution layer. The high-level object information s may be defined as class-aware information including class information. At this time, the prediction head layer 2215 may extract class information of each object from object-wise information.

The second network model 222 may perform training using the second augmented data T₃ input from the data augmentation model 210. The second network model 222 may receive the weight transmitted from the first network model 221 and may update its weight.

The second network model 222 may include a pre-process layer 2220, a backbone layer 2221, a detection head layer 2222, a projection head layer 2224, and a prediction head layer 2225. Because functions of the components 2220, 2221, 2222, 2224, and 2225 corresponds to the components in the first network model 221, respectively, they will be briefly described.

The pre-process layer 2220 may receive the second augmented data transmitted from the data augmentation model 210. The pre-process layer 2220 may pre-process the received second augmented data.

The backbone layer 2221 may extract a global feature (or a global feature map) from the pre-processed second augmented data.

The detection head layer 2222 may detect an object based on the extracted global feature. The detection head layer 2222 may detect at least one object from the second augmented data using the region proposal network (RPN).

The detection head layer 2222 may estimate and output a class probability and an object position probability for the detected object. The detection head layer 2222 may output a probability of each class (i.e., the class probability) for the detected object. For example, the detection head layer 2222 may estimate and output a probability that the detected object will be a car, a probability that the detected object will be a pedestrian, a probability that the detected object will be a bus, a probability that the detected object will be a truck, a probability that the detected object will be a van, and the like. Furthermore, the detection head layer 2222 may estimate a probability that the detected object will be located at a specific point (i.e., the object position probability).

The projection head layer 2224 may extract low-level object information (or second low-level object information) z′ from the global feature extracted by the backbone layer 2221. The low-level object information z′ may be class-agnostic information or instance-agnostic information which does not include class information.

The prediction head layer 2225 may extract high-level object information (or second high-level object information) s′ from the low-level object information z′ extracted by the projection head layer 2224 using the convolution layer. The high-level object information s′ may be class-aware information including class information.

The training model 220 may calculate a difference between an output (or feature representation) of the first network model 221 and an output (or feature representation) of the second network model 222 as a training loss. The training model 220 may calculate a total training loss Lₜₒₜₐₗ using Equation 1 below. The total training loss Lₜₒₜₐₗ may include an RPN loss (or a detection loss) Lᵣₚₙ and feature representation losses L_{agnostic} and L_{aware}.

$${L}_{total} = {w}_{1} {L}_{rpn} ( {f}_{q} ) + {w}_{2} {L}_{a g n o s t i c} ( z , {z}^{′} ) + {w}_{3} {L}_{aware} ( s , {s}^{′} ) \qquad Equation l$$

Herein, w₁, w₂, and w₃ may be hyperparameters, which may be the weights of the respective terms, f_{q} may be the feature map output from the detection head layer 2212, z and z′ may be the feature maps output from the projection head layers 2214 and 2224, and s and s′ may be the feature maps output from the prediction head layers 2215 and 2225.

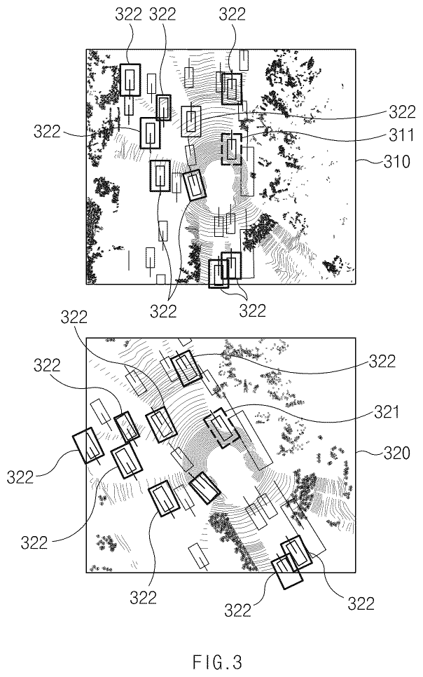

FIG. 3 is a drawing illustrating a method for training an object detection model according to embodiments of the present disclosure.

A training model 220 may receive a first view 310 and a second view 320, which are augmented. The second view 320 may be generated by applying random global rotation to the first view 310. The training model 220 may input the first view 310 to a first network model 221 and may input the second view 320 to a second network model 222.

The first network model 221 may detect anchors mapped to corresponding GT for each GT from the first view 310. The second network model 222 may detect anchors mapped to corresponding GT for each GT from the second view 320. The first network model 221 and the second network model 222 may determine which GT and IoU are highest for each anchor, may assign a label to the highest GT and IoU, and may use the GT and IoU to which the label is assigned for training.

The training model 220 may generate positive pairs based on the anchors respectively detected from the different views. Pieces of information of the anchors generated from the different views for each GT may be included in the positive pairs.

The training model 220 may perform class-agnostic proposal feature representation learning. The training model 220 may regard objects which are present in one scene as an instance with each label to apply an MSE loss to the objects. In other words, the training model 220 may apply a feature distillation loss for each object using a feature point included in the low-level object information.

The first network model 221 may extract a feature vector of one object 311 as a positive sample from the first view 310. The first network model 221 may extract feature vectors of the remaining other objects except for the object 311 extracted as the positive sample from the first view 310 as negative samples.

The second network model 222 may extract a feature vector of an object 321 corresponding to the object 311 extracted from the first view 310 as a positive sample from the second view 320. The second network model 222 may extract feature vectors of the remaining other objects except for the object 321 extracted as the positive sample from the second view 320 as negative samples.

The training model 220 may calculate an error between an object predicted by the first network model 221 and an object predicted by the second network model 222. The training model 220 may calculate an error for each object and may calculate an average of values obtained by squaring the calculated error.

$$Loss = \frac{1}{K} {\sum }_{k = 0}^{K} mse ( \frac{1}{L} {\sum }_{l = 0}^{L} {z}_{l}^{k} , \frac{1}{L} {\sum }_{l = 0}^{L} {z}_{l}^{′ k} ) \qquad Equation 2$$

Herein, K may refer to the number of all objects, L may refer to the number of all proposals indicating the kth object, zₗ^{k} may refer to the Ith proposals representing the kth object among the results z output from the projection head layer 2214 of the first network model 221, and zₗ′^{k} may refer to the Ith proposals representing the kth object among the results z′ output from the projection head layer 2224 of the second network model 222.

The training model 220 may calculate a first average of the proposals representing the kth object output from the first network model 221 and a second average of the proposals representing the kth object output from the second network model 222. The training model 220 may calculate the first average and the second average for each object and may calculate and square an error between the first average and the second average calculated for each object, thus calculating an average of the squared values.

The training model 220 may perform class-aware proposal feature representation learning. The training model 220 may apply a feature distillation loss for each class based on class information of objects which are present in one scene. The training model 220 may apply an MSE loss for each class using a feature point included in the high-level object information.

The first network model 221 may extract all objects 311 and 322 corresponding to a first class from the first view 310. The first network model 221 may extract feature vectors of all proposals representing the objects 311 and 322 which belong to the first class from the first view 310. The first network model 221 may extract feature vectors of all proposals in a second class from the first view 310. Herein, the second class may refer to the remaining other class except for the first class.

The second network model 222 may extract all objects 321 and 322 corresponding to the first class from the second view 320. The second network model 222 may extract feature vectors of all proposals representing the objects 321 and 322 which belong to the first class from the second view 320. The second network model 222 may extract feature vectors of all proposals in the second class from the second view 320.

The training model 220 may calculate an error between the sum of the feature vectors of the objects in the first class, which are extracted by the first network model 221, and the sum of the feature vectors of the objects in the first class, which are extracted by the second network model 222. The training model 220 may calculate an error for each class and may calculate an average of values obtained by squaring the calculated error.

$$Loss = \frac{1}{N} {\sum }_{n = 0}^{N} mse ( \frac{1}{M} {\sum }_{m = 0}^{M} {s}_{m}^{n} , \frac{1}{M} {\sum }_{m = 0}^{M} {s}_{m}^{′ n} ) \qquad Equation 3$$

Herein, N may refer to the total number of classes, M may refer to the number of proposals with the n class index, sₘⁿ may refer to the mth proposals among the proposals of all objects with the n class index among the results z output from the prediction head layer 2215 of the first network model 221, and sₘ′ⁿ may refer to the mth proposals among the proposals of all objects with the n class index among the results s′ output from the prediction head layer 2225 of the second network model 222.

The training model 220 may calculate a loss for all objects corresponding to the nth class on a class-by-class basis. For example, the training model 220 may calculate an average value for all of proposals representing all objects corresponding to class “car” and may calculate an MSE loss.

The method for training the object detection model according to an embodiment may be to predict a semantic label for each anchor when performing supervised learning and may predict what class the anchor is. Furthermore, the method for training the object detection model may be to add a distillation loss for each class and an instance-wise distillation loss for each object in the foreground, thus reducing an error of non-recognition and/or misrecognition as well as semantic information. Furthermore, the method for training the object detection model may be to directly learn feature representation of various objects to perform discrimination between object anchor proposals overlapping with an actual GT box.

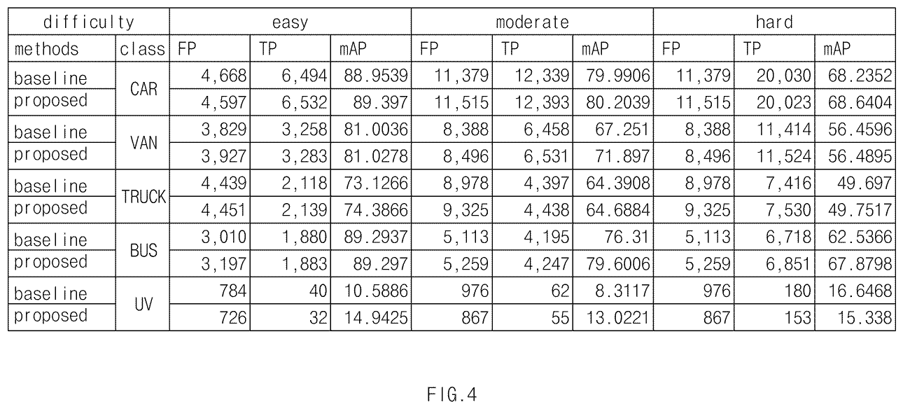

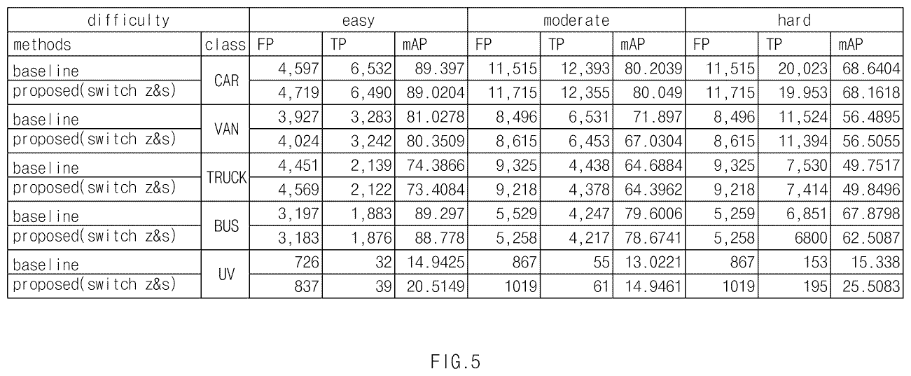

FIGS. 4 and 5 are drawings for describing the result of evaluating a method for training an object detection model according to embodiments of the present disclosure.

First of all, the result trained by applying a training technique according to an embodiment of the present disclosure is compared with the result of training a base model using supervised learning to perform quantitative evaluation. At this time, the quantitative evaluation is performed using mean average precision (mAP) which is an evaluation method generally most used in the field of object detection.

Referring to FIG. 4, seeing misrecognition performance indexes, false positive (FP), of a training technique proposed in the present disclosure and a baseline trained by applying the base model, because the proposed training technique has higher FP than the baseline, but has high true positive (TP) and a high mAP numerical value, it may be seen that the proposed training technique is better in performance than the baseline.

Next, the proposed training technique in the present disclosure is compared with a training technique for switching an order in which a feature representation loss is applied in the proposed training technique to perform quantitative evaluation.

Referring to FIG. 5, because the proposed training technique has a lower FP numerical value and a higher TP and mAP numerical value than a training technique for switching an order in which feature representation loss is applied, an order in which a class-agnostic loss using results of projection head layers 2214 and 2224 and a class-aware loss using results of prediction head layers 2215 and 2225 are applied is verified. In other words, it is identified that the application of the class-agnostic loss is appropriate because the outputs of the projection head layers 2214 and 2224 include low-level object information and the application of the class-aware loss is appropriate because the outputs of the prediction head layers 2215 and 2225 include high-level object information.

The above-mentioned training technique according to embodiments performs training such that feature representation for each object and feature representation for each class are similar to each other, such that even objects which belong to the same class maintain a robust 3D object detection capability even for objects with different shapes.

Furthermore, because the above-mentioned training technique according to embodiments proceeds in the same structure as an existing baseline upon inference, it may maintain an inference time as it is and may increase performance.

Furthermore, when the system is horizontally deployed for different vehicle types with different sensor configurations, the above-mentioned training technique according to embodiments may achieve the same effect as domain adaptation.

Furthermore, because the above-mentioned training technique according to embodiments trains feature representation for each object and feature representation for each class in a similar manner, it may detect an object although feature representations of objects obtained by different sensors are differently represented.

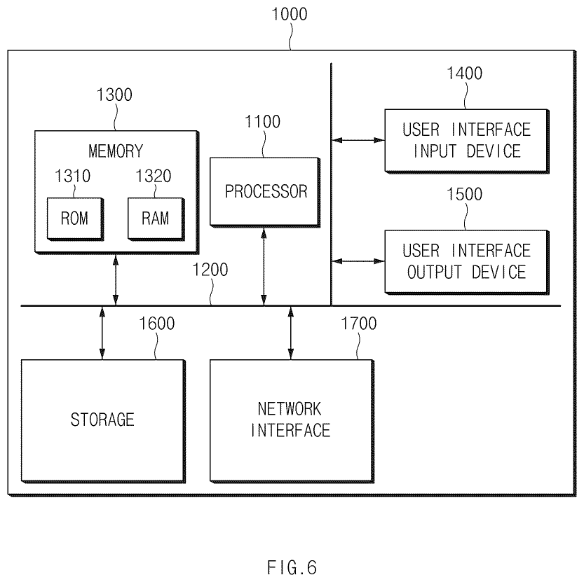

FIG. 6 is a block diagram illustrating a computing system for executing a method for training an object detection model according to embodiments of the present disclosure.

Referring to FIG. 6, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM. The exemplary storage medium may be coupled to the processor 1100. The processor 1100 may read out information from the storage medium and may write information in the storage medium. Alternatively, the storage medium may be integrated with the processor 1100. The processor 110 and the storage medium may reside in an application specific integrated circuit (ASIC). The ASIC may reside within a user terminal. In another case, the processor 1100 and the storage medium may reside in the user terminal as separate components.

Embodiments of the present disclosure may train an object detection model using a feature representation learning technique which uses a distillation loss, thus improving 3D object detection performance.

Furthermore, embodiments of the present disclosure may maintain an existing network architecture and may improve the 3D object detection performance.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims. Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

1. An object detection apparatus, comprising:
a memory configured to store an object detection model; and
a processor configured to train the object detection model, wherein the processor is further configured to:
augment input data to generate first augmented data and second augmented data;
input the first augmented data into a first network model and input the second augmented data into a second network model; and
train the object detection model based on an output of the first network model and an output of the second network model.

2. The object detection apparatus of claim 1, wherein the processor is further configured to:
calculate a distillation loss for each object based on first low-level object information output from the first network model and second low-level object information output from the second network model;
calculate a distillation loss for each class based on first high-level object information output from the first network model and second high-level object information output from the second network model; and
apply the distillation loss for each object and the distillation loss for each class to train the object detection model.

3. The object detection apparatus of claim 2, wherein the processor is further configured to:
extract the first high-level object information from the first low-level object information using a convolution layer; and
extract the second high-level object information from the second low-level object information using the convolution layer.

4. The object detection apparatus of claim 2, wherein the first low-level object information and the second low-level object information are defined as class-agnostic information which does not include class information.

5. The object detection apparatus of claim 2, wherein the first high-level object information and the second high-level object information are defined as class-aware information including class information.

6. The object detection apparatus of claim 2, wherein the processor is further configured to calculate the distillation loss for each object and the distillation loss for each class using a mean squared error (MSE) loss function.

7. The object detection apparatus of claim 2, wherein the processor is further configured to:
calculate an average of all proposals representing a kth object in each of the first low-level object information and the second low-level object information; and
calculate the distillation loss for each object based on the calculated average.

8. The object detection apparatus of claim 2, wherein the processor is further configured to:
calculate an average of all proposals representing all objects included in an nth class in each of the first high-level object information and the second high-level object information; and
calculate the distillation loss for each class based on the calculated average.

9. The object detection apparatus of claim 2, wherein the first network model outputs a weight as a trained result and shares the weight with the second network model using an exponential moving average (EMA); and
wherein the second network model updates a second weight using the weight shared by the first network model.

10. The object detection apparatus of claim 1, wherein the processor is further configured to:
perform global augmentation of the input data to generate the first augmented data; and
apply random global rotation to the first augmented data to generate the second augmented data.

11. A method for training a model of an object detection apparatus, the method comprising:
augmenting, by a processor, input data to generate first augmented data and second augmented data;
inputting the first augmented data into a first network model and inputting the second augmented data into a second network model; and
training an object detection model based on an output of the first network model and an output of the second network model.

12. The method of claim 11, wherein training the object detection model includes:
calculating a distillation loss for each object based on first low-level object information output from the first network model and second low-level object information output from the second network model;
calculating a distillation loss for each class based on first high-level object information output from the first network model and second high-level object information output from the second network model; and
applying the distillation loss for each object and the distillation loss for each class to train the object detection model.

13. The method of claim 12, wherein calculating the distillation loss for each class includes:
extracting the first high-level object information from the first low-level object information using a convolution layer; and
extracting the second high-level object information from the second low-level object information using the convolution layer.

14. The method of claim 12, wherein the first low-level object information and the second low-level object information are defined as class-agnostic information which does not include class information.

15. The method of claim 12, wherein the first high-level object information and the second high-level object information are defined as class-aware information including class information.

16. The method of claim 12, wherein training the object detection model includes:
calculating the distillation loss for each object and the distillation loss for each class using an MSE loss function.

17. The method of claim 12, wherein calculating the distillation loss for each object includes:
calculating an average of all proposals representing a kth object in each of the first low-level object information and the second low-level object information; and
calculating the distillation loss for each object based on the calculated average.

18. The method of claim 12, wherein calculating the distillation loss for each class includes:
calculating an average of proposals representing all objects included in an nth class in each of the first high-level object information and the second high-level object information; and
calculating the distillation loss for each class based on the calculated average.

19. The method of claim 11, further comprising:
outputting, by the first network model, a weight as a trained result;
sharing, by the first network model, the weight with the second network model using an EMA; and
updating, by the second network model, a second weight using the weight shared by the first network model.

20. The method of claim 11, wherein generating the first augmented data and the second augmented data includes:
performing global augmentation of the input data to generate the first augmented data; and
applying random global rotation to the first augmented data to generate the second augmented data.
